(19) United States
(12) Patent Application Publication
(10) Pub. No.: US 2018/0156483 A1
(43) Pub. Date: Jun. 7, 2018

(54) CONTROL OF AN ENVIRONMENTAL CONDITION MANIPULATING APPLIANCE

(71) Applicant: Bitfinder, Inc., San Francisco, CA (US)

(72) Inventors: Dae-oong KIM, Seoul (KR); Bosung KIM, San Carlos, CA (US); Ronald RO, Sunnyvale, CA (US); Kevin CHO, Pleasanton, CA (US)

(73) Assignee: Bitfinder, Inc., San Francisco, CA (US)

(21) Appl. No.: 15/367,104

(22) Filed: Dec. 1, 2016

(51) Int. Cl. F24F 11/00; G05B 15/02

(52) U.S. Cl. CPC F24F 11/006; G05B 15/02; F24F 11/0034; F24F 2011/0061; F24F 2011/0071; F24F 2011/0047; F24F 2011/0057; F24F 11/0017

(57) ABSTRACT

According to an example, an apparatus for controlling an appliance may include a processor and a machine-readable storage medium on which is stored instructions. The instructions may cause the processor to track an environmental condition, generate air quality data from the tracked environmental condition, communicate the generated air quality data to a server, receive a command for the appliance from the server, in which the command may correspond to the generated air quality data, and cause the appliance to operate according to the received command.

### CROSS-REFERENCE TO RELATED APPLICATION

This application shares some subject matter with commonly assigned and co-pending U.S. patent application Ser. No. TBD (Attorney Docket No. 1097.003), filed on even date herewith, the disclosure of which is hereby incorporated by reference in its entirety.

### BACKGROUND

The measurement and evaluation of indoor air quality have improved over time. For instance, an increasing number of air quality monitoring devices that have a number of features as well as relatively compact sizes are becoming more readily available. The air quality monitoring devices typically measure the conditions inside of a space, such as a residential, commercial, or industrial environment. The measured conditions may be evaluated to determine whether the conditions are at healthy and/or comfortable levels and modifications to the conditions, such as temperature and humidity, may be made based upon the outcome of the evaluated conditions.

### BRIEF DESCRIPTION OF THE DRAWINGS

Features of the present disclosure are illustrated by way of example and not limited in the following figure(s), in which like numerals indicate like elements, in which:

FIG. 1 shows a simplified block diagram of a system within which an example appliance controlling apparatus may be implemented, according to an example;

FIG. 2 shows a block diagram of the example appliance controlling apparatus depicted in FIG. 1, according to an example;

FIG. 3 depicts another block diagram of the example appliance controlling apparatus depicted in FIGS. 1 and 2, according to another example; and

FIGS. 4-7, respectively, depict methods for controlling an environmental condition manipulating appliance in a structure, according to examples.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein are apparatuses for controlling an environmental condition manipulating appliance and methods for controlling the apparatus and the appliance. The apparatuses disclosed herein may track an environmental condition in a structure and may generate air quality data from the tracked environmental condition. The apparatuses may also communicate the generated air quality data to a server and may receive a command for the appliance from the server, in which the command may correspond to the generated air quality data. In addition, the apparatuses may cause the appliance to operate according to the received command. The server may be a remotely located and network-accessible server, such as a cloud-based server.

According to examples, the apparatuses may control operations of the appliance to vary environmental conditions in the structure. For instance, the apparatuses may determine occupancy information in the structure and may control the environmental conditions based upon the determined occupancy information. The control of the environmental conditions may be determined by the server based upon the occupancy information determined by the apparatus. In this example, the appliance may be activated in instances in which the structure is determined to be occupied, for instance, to minimize energy consumption of the appliance. As another example, the apparatuses may monitor energy consumption levels of the appliance and the appliance may be controlled to minimize energy consumption. As a further example, the apparatuses may monitor a user's interactions with the appliance along with the environmental conditions corresponding to the times at which the user's interactions are monitored. In this example, the user's desired environmental conditions may be determined and the appliance may be operated according to the desired environmental conditions.

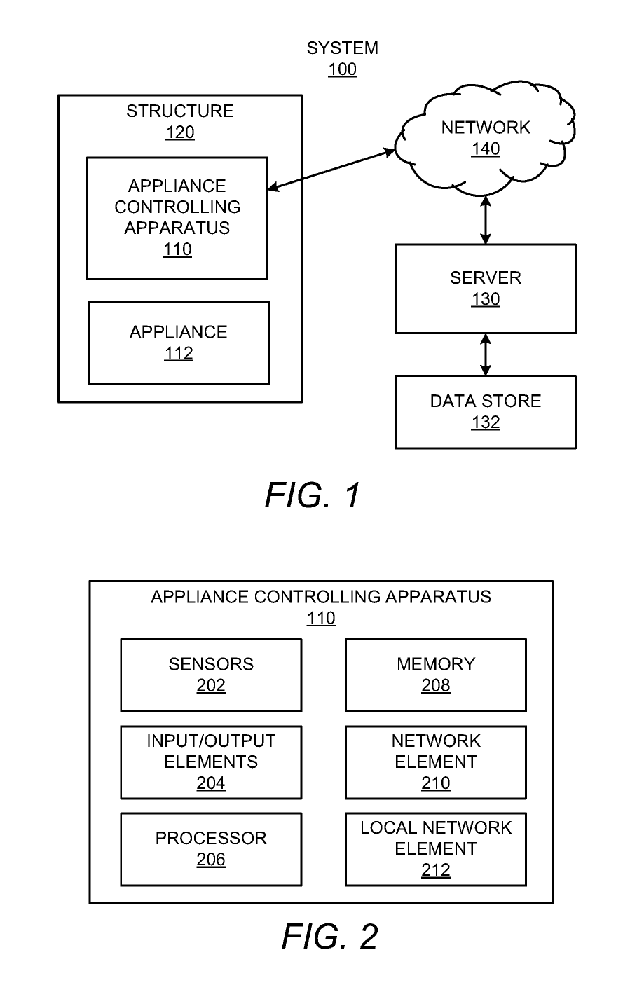

With reference first to FIG. 1, there is shown a simplified block diagram of a system 100 within which an example appliance controlling apparatus 110 may be implemented, according to an example. It should be understood that the system 100 depicted in FIG. 1 may include additional components and that some of the components described herein may be removed and/or modified without departing from the scope of the system 100.

The system 100 is depicted as including an appliance controlling apparatus 110 (which is also referenced herein as an apparatus 110) and an environmental condition manipulating appliance 112 (which is also referenced herein as an appliance 112). The apparatus 110 and the appliance 112 are shown as being positioned within a structure 120. The structure 120 may be an indoor structure such as a room in a house, an office in an office building, a gym, a warehouse, or the like. The structure 120 may also be an entire house, office building, etc., or other relatively enclosed space, such as a vehicle, an airplane, or the like. According to an example, and as discussed in greater detail herein below, the apparatus 110 may track one or more environmental conditions, such as temperature, humidity, carbon dioxide concentration, volatile organic compounds, dust concentration, dust levels, etc., inside the structure 120. The apparatus 110 may also track other features, such as motion, energy consumption, user interactions with the appliance 112, etc. In addition, the apparatus 110 may communicate data pertaining to the tracked environmental condition(s) as well as the other features to a server 130 as also discussed in greater detail herein below.

The appliance 112 may modify one or more of the environmental conditions. For instance, the appliance 112 may be an air conditioning system, a humidifier, a de-humidifier, an air purifier, a heating system, a fan, an actuator for a window, a ventilation system, or the like. In other examples, the appliance 112 may also include other types of devices, such as lights, doors, network connected devices, etc. The apparatus 110 may communicate with the appliance 112 via a wired and/or a wireless connection and may control the appliance 112 to modify the environmental condition(s). As discussed in greater detail herein, the apparatus 110 and/or the server 130 may determine that the appliance 112 is to modify an environmental condition in the structure 120 and may cause the appliance to modify the environmental condition. The apparatus 110 may make this determination and/or may receive a command for the appliance 112 from the server 130 to modify the environmental condition. The apparatus 110 may thus determine how the appliance is to be manipulated and/or the server 130 may make this determination. Various manners in which the determination as to how the appliance 112 is to be manipulated are discussed in greater detail herein.

As shown in FIG. 1, the apparatus 110 may communicate with the server 130, which may be a cloud-based server. In this regard, the apparatus 110 may communicate with the server 130 via a network 140, which may be the Internet. The server 130 may be a server computer and/or a virtual server operating on a physical computer. The server 130 may communicate with a plurality of apparatuses 110 and may also store received air quality data in a data store 132. For instance, the server 130 may store the received air quality data in databases on the data store 132. Additionally, although a single server 130 has been shown in FIG. 1, it should be understood that multiple servers may implement the features of the server 130 discussed herein. By way of example, a first server may receive the environmental condition data and may forward the received environmental condition data to a second server and the second server may analyze the received air quality data.

In any regard, the server 130 may have stored thereon machine readable instructions that are to analyze the air quality data received from the apparatus 110 to determine, for instance, various environmental and other characteristics of the interior of the structure 120. In some examples, the server 130 may include machine readable instructions that are to cause a processor of the server 130 to generate a command for the appliance 112 based upon the analysis of the air quality data. The server 130 may also generate the command based upon other information, such as occupancy information, energy consumption information, user interaction information, etc. The server 130 may further communicate the generated command to the apparatus 110 via the network 140 and the apparatus 110 may cause the appliance 112 to operate according to the received command.

The server 130 may implement an environmental condition management operation with respect to the air quality in the structure 120. For instance, the server 130 may determine whether the air quality within the structure 120 is within a desirable range or if the air quality is abnormal, e.g., outside of a predetermined range. In response to a determination that the air quality within the structure 120 is abnormal, the server 130 may output an instruction to the apparatus 110 to cause the appliance 112 to modify an appropriate environmental condition. Various other examples with respect to the management operations that may be determined by the apparatus 110 and/or the server 130 are discussed in greater detail hereinbelow.

Although a single appliance 112 has been depicted in FIG. 1, it should be understood that multiple appliances 112 may be included in the structure 120 and that the apparatus 110 may control the multiple appliances 112. In some examples, the appliances 112 may modify the same type of environmental condition and in other examples, the appliances 112 may modify different types of environmental conditions. The appliances 112 may also be located in various locations throughout the structure 120, e.g., in a bedroom, in a kitchen, in a bathroom, etc. The apparatus 110 may communicate with the appliances 112 through a wifi connection, a Bluetooth™ connection, a wired connection, or the like.

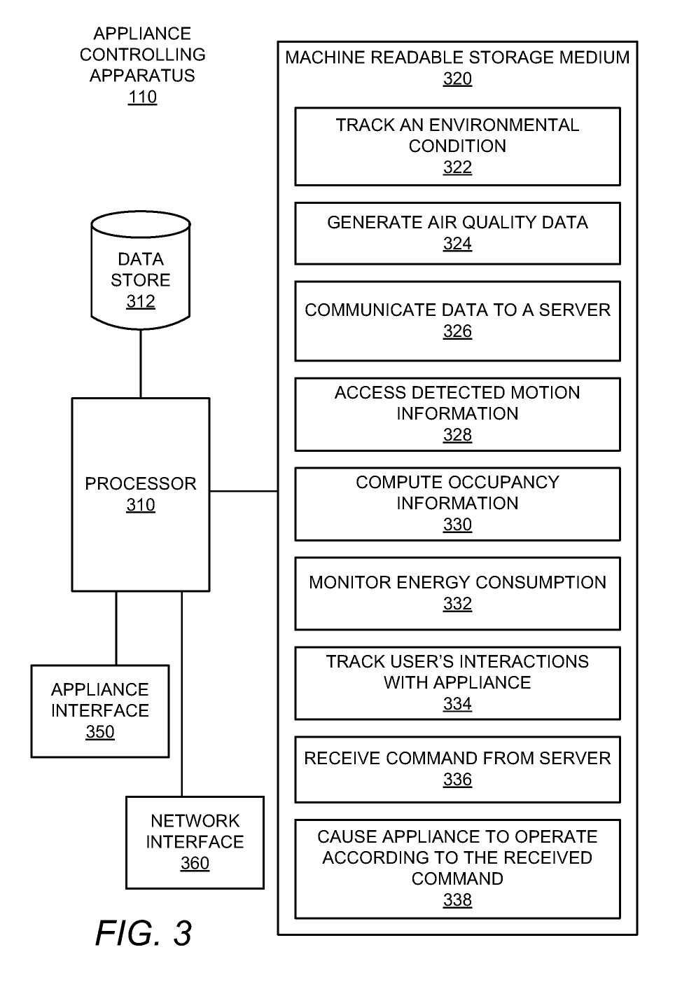

Turning now to FIG. 2, there is shown a block diagram of the appliance controlling apparatus 110 depicted in FIG. 1, according to an example. It should be understood that the appliance controlling apparatus 110 depicted in FIG. 2 may include additional components and that some of the components described herein may be removed and/or modified without departing from the scope of the appliance controlling apparatus 110.

As shown in FIG. 2, the apparatus 110 may include a plurality of sensors 202. The sensors 202 may include, for instance, sensors that track or detect various environmental conditions, such as temperature, humidity, carbon dioxide concentration, volatile organic compounds, dust, carbon monoxide, or the like. The sensors 202 may also include, for instance, sensors that detect motion inside the structure 120, e.g., movement by occupants inside the structure 120. The occupants may be humans and/or other types of animals. In other examples, one or more of the sensors 202 may be positioned externally to the apparatus 110 and the apparatus 110 may access information related to the detected environmental conditions and/or the detected motion from the externally located sensor(s). For instance, one or more of the sensor 202 may be included in a device that is separate from the apparatus 110.

In addition, the apparatus 110 may include input/output elements 204, which may include, for instance, a microphone, a camera, a speaker, a digital display, lights, a user interface, command buttons, etc. Thus, for instance, the apparatus 110 may receive audible inputs from users and may also output visual and/or auditory signals to users. By way of example, the apparatus 110 may receive voice commands and/or may output information audibly.

The apparatus 110 may further include a processor 206 and a memory 208. The processor 206 may be a semiconductor-based microprocessor, a central processing unit (CPU), an application specific integrated circuit (ASIC), and/or other hardware device. The memory 208 may store, for instance, environmental data collected by the sensors 202 and/or input received through the input/output elements 204. The memory 208 may also store instructions that the processor 206 may execute in collecting, storing, and communicating environmental data as well as in receiving user inputs and outputting information to users. In any regard, the memory 208 may be a Random Access Memory (RAM), an Electrically Erasable Programmable Read-Only Memory (EEPROM), a storage device, an optical disc, or the like.

The apparatus 110 may further include a network element 210 and a local network element 212. The network element 210 may include hardware to enable the apparatus 110 to communicate over the network 140. For instance, the network element 210 may include an antenna through which the processor 206 may wirelessly send and receive wifi signals. The local network element 212 may include hardware to enable the apparatus 110 to communicate with the appliance 112 as well as nearby user devices, such as mobile telephones, tablet computers, personal computers, laptop computers, etc. The local network element 212 may include, for instance, hardware to enable communication via BLUETOOTH™, ZIGBEE™, or the like.

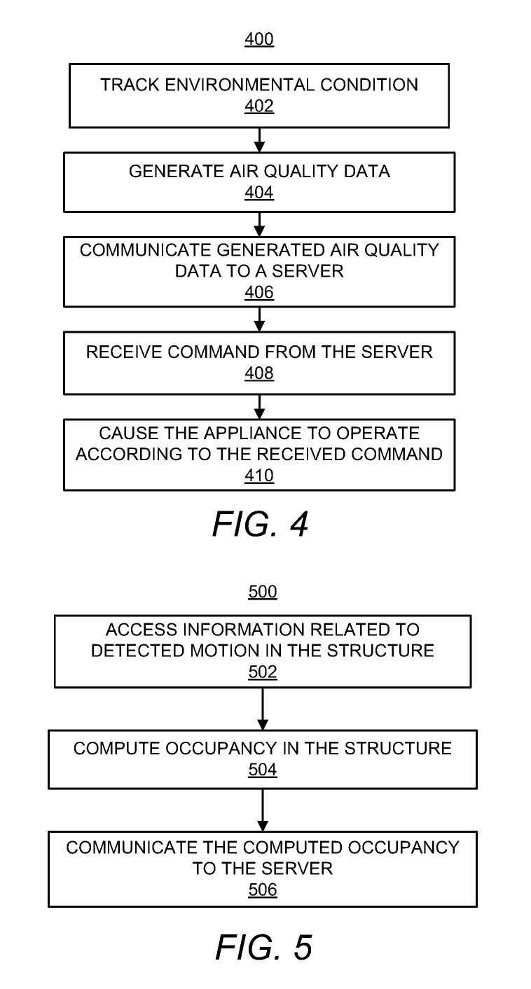

According to examples, the apparatus 110 may be a standalone device that is to be placed in a location within the structure 120 at which environmental conditions are to be tracked or monitored. In other examples, the apparatus 110 may be integrated with the appliance 112. Various manners in which the apparatus 110 may be implemented are described in greater detail below with respect to FIGS. 3-7

With reference first to FIG. 3, there is shown a block diagram of the example appliance controlling apparatus 110 depicted in FIGS. 1 and 2 according to another example. It should be understood that the appliance controlling apparatus 110 depicted in FIG. 3 may include additional components and that some of the components described herein may be removed and/or modified without departing from the scope of the appliance controlling apparatus 110.

The apparatus 110 may include a processor 310 and a data store 312. The processor 310 may be a semiconductor-based microprocessor, a central processing unit (CPU), an application specific integrated circuit (ASIC), and/or other hardware device. The data store 312 may be a Random Access Memory (RAM), an Electrically Erasable Programmable Read-Only Memory (EEPROM), a storage device, an optical disc, or the like. In addition, the data store 312 may store, for instance, tracked environmental condition data, tracked motion information, etc.

The apparatus 110 may also include a machine readable storage medium 320 on which is stored machine readable instructions 322-338 that the processor 310 may execute. More particularly, the processor 310 may fetch, decode, and execute the instructions 322 to track an environmental condition, the instructions 324 to generate air quality data, the instructions 326 to communicate data to a server, the instructions 328 to access detected motion information, the instructions 330 to compute occupancy information, the instructions 332 to monitor energy consumption of an appliance, the instructions 334 to track a user's interactions with an appliance, the instructions 336 to receive a command from a server, and the instructions 338 to cause an appliance to operate according to the received command. As an alternative or in addition to retrieving and executing instructions, the processor 310 may include one or more electronic circuits that include electronic components for performing the functionalities of the instructions 322-338.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage device, an optical disc, and the like. The machine-readable storage medium 320 may be a non-transitory machine-readable storage medium, where the term “non-transitory” does not encompass transitory propagating signals.

The processor 310 may generate instruction signals and may communicate the instruction signals to an appliance 112 via an appliance interface 350 to cause the appliance 112 to operate according to the received command. In addition, the processor 310 may communicate data to and may receive data from a server 130 via a network interface 360. The appliance interface 350 and the network interface 360 may each include hardware and/or software to enable the communication of information.

According to an example, the apparatus 110 may include a plurality of processors 310 and/or a processor 310 containing a plurality of cores. In these examples, each the plural processors 310 and/or cores may operate in parallel, i.e., use parallel processing techniques to analyze various different information received from respective ones of multiple sensors 202. In this regard, the use of multiple processors 310 and/or cores may reduce the amount of time required to receive, analyze, and manage environmental conditions and other data.

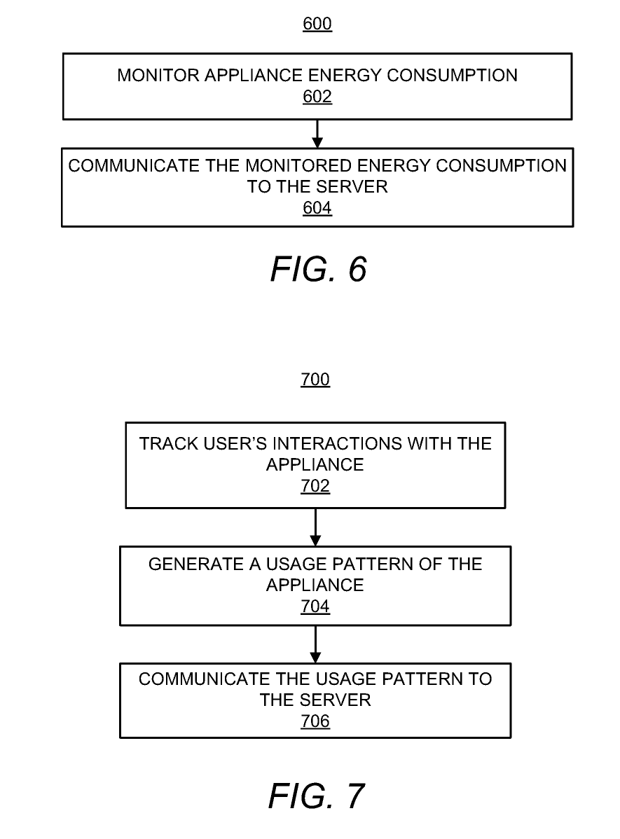

Turning now to FIGS. 4-7, there are shown methods 400-700 for controlling an appliance 112 in a structure 120, according to examples. It should be apparent to those of ordinary skill in the art that the methods 400-700 may represent generalized illustrations and that other operations may be added or existing operations may be removed, modified, or rearranged without departing from the scopes of the methods 400-700.

The descriptions of the methods 400-700 are made with reference to the apparatus 110 illustrated in FIGS. 1-3 for purposes of illustration. It should, however, be understood that apparatuses having other configurations may be implemented to perform any of the methods 400-700 without departing from the scopes of the methods 400-700.

With reference first to FIG. 4, at block 402, the processor 310 may execute the instructions 322 to track an environmental condition of an interior of a structure 120. In some examples, the processor 310 may track the environmental condition through a sensor 202 that is integrated with the apparatus 110, for instance, as shown in FIG. 2. In other examples, the processor 310 may track the environmental condition through receipt of the environmental condition from a sensor located externally to the apparatus 110. As discussed above, the tracked environmental condition may be any of temperature, humidity, carbon dioxide concentration, volatile organic compounds, dust concentration, or the like. Additionally, although a single environmental condition is discussed with respect to the methods 400-700, the processor 310 may similarly track multiple environmental conditions.

The processor 310 may also store the tracked environmental condition in the data store 312. According to examples, the processor 310 may track the environmental condition at periodic intervals, for instance, at predetermined times during a day, in response to detected changes in environmental condition, at predetermined intervals in time, or the like.

At block 404, the processor 310 may execute the instructions 324 to generate air quality data from the tracked environmental condition. In some examples, the processor 310 may generate the air quality data by encapsulating the tracked environmental condition into a data packet. In other examples, the processor 310 may generate the air quality data by collecting multiple environmental condition data, e.g., over a period of time, and encapsulating the collected environmental condition into a data packet.

At block 406, the processor 310 may execute the instructions 326 to communicate to the generated air quality data to a server 130 over a network 140, e.g., via the network interface 360. The server 130 may generate a command for an appliance 112 based upon the air quality data received from the processor 310. The server 130 may generate the command to cause the appliance 112 to modify an environmental condition in the structure 120 interior. For instance, the server 130 may determine that an environmental condition in the structure 120 is to be modified based upon an analysis of the air quality data. By way of particular example in which the appliance 112 is a heating device, the server 130 may determine that the appliance 112 is to increase the temperature inside the structure 120 in response to the air quality data indicating that the temperature inside the structure 120 is below a predetermined temperature. In other examples, the server 130 may determine that an environmental condition in the structure 120 is to be modified, for instance, such that the environmental condition inside the structure 120 is within a predetermined range while minimizing energy consumption of the appliance 112. In any regard, the server 130 may communicate the generated command to the apparatus 110 via the network 140.

At block 408, the processor 310 may execute the instructions 336 to receive the generated command for the appliance 112 from the server 130, e.g., via the network interface 360. In addition, at block 410, the processor 310 may execute the instructions 338 to cause the appliance 112 to operate according to the received command. For instance, the processor 310 may generate an instruction signal for the appliance 112 that corresponds to the received command, i.e., the instruction signal is to carry out the received command. The processor 310 may also communicate the instruction signal to the appliance 112, e.g., through the appliance interface 350.

Turning now to FIG. 5, there is shown an example method 500, which may be executed in conjunction with or as an alternative to the method 400. At block 502, the processor 310 may execute the instructions 328 to access information related to detected motion in the structure 120. In some examples, the processor 310 may access the detected motion information through a sensor 202 that is integrated with the apparatus 110, for instance, as shown in FIG. 2. In other examples, the processor 310 may access the information through receipt of the detected motion information from a sensor located externally to the apparatus 110. In any regard, the detected motion information may pertain to motion detected inside the structure 120.

At block 504, the processor 310 may execute the instructions 330 to compute an occupancy in the structure 120 based upon the accessed detected motion information and a tracked environmental condition. The tracked environmental condition may be the environmental condition tracked at block 402 in FIG. 4. According to examples, the processor 310 may compute a heuristically correct occupancy in the structure 120 via processing of the accessed the detected motion information and the tracked environmental condition in a windowed fashion. That is, the processor 310 may compute the occupancy in the structure 120 at multiple windows of time.

The processor 310 may compute the heuristically correct occupancy in the structure 120 through use of an environmental condition such as carbon dioxide level, dust level, or the like, in addition to the detected motion information. The computed occupancy may be relatively more accurate than may be possible through analysis of the detected motion information itself. For instance, the processor 310 may access a lookup table that identifies correlations between carbon dioxide levels and predicted numbers of occupants to determine the number of occupants in the structure 120 based upon a detected carbon dioxide level. In other examples, the processor 310 may determine a predicted number of people inside the structure 120 based upon the CO₂ concentration level detected in the structure 120. That is, the processor 310 may use the average amount of CO₂ that a person typically generates and may divide the detected CO₂ concentration level with the average amount to predict the occupancy in the structure 120. In any of the examples, the processor 310 may make the occupancy determination, for instance, in response to a determination that a motion sensor detected motion in the structure 120. In addition or as another example, the processor 310 may determine that the structure 120 is not occupied even though the detected carbon dioxide level is sufficiently high to indicate that the structure 120 is occupied in response to a determination that a motion sensor did not detect motion in the structure 120.

At block 506, the processor 310 may execute the instructions 326 to communicate the computed occupancy to the server 130 via the network interface 360. The server 130 may generate the command for the appliance 112 based upon the computed occupancy. For instance, the server 130 may generate a command for the appliance 112 to be turned off in response to the computed occupancy indicating that the structure 120 is vacant. As another example, the server 130 may generate a command for the appliance 112 to increase activity in response to the computed occupancy indicating that the number of occupants in the structure 120 exceeds a predefined number. In any regard, the processor 310 may receive the generated command from the server 130 via the network interface 360 and may cause the appliance 112 to be operated according to the received command.

According to examples, the processor 310 may track changes in occupancy in the structure 120 at block 504. In addition, the processor 310 may communicate a determined change in occupancy to the server 130 at block 506 in response to a determination that the occupancy in the structure 120 has changed.

Turning now to FIG. 6, there is shown an example method 600, which may be executed in conjunction with or as an alternative to the methods 400 and 500. At block 602, the processor 310 may execute the instructions 332 to monitor energy consumption of the appliance 112. The processor 310 may monitor the energy consumption levels of the appliance 112 by, for instance, receiving the energy consumption levels from the appliance 112. In other examples, the processor 310 may access the energy consumption levels of the appliance 112 from a sensor or meter that tracks the energy consumption levels.

At block 604, the processor 310 may execute the instructions 326 to communicate the monitored energy consumption to the server 130 via the network interface 360. The server 130 may generate the command for the appliance 112 based upon the monitored energy consumption. For instance, the server 130 may determine how the appliance 112 is to be manipulated based upon the monitored energy consumption levels of the appliance 112. By way of particular example, the server 130 may determine that the appliance 112 is to be operated at a reduced operating level in response to a determination that the appliance 112 is consuming energy at a level that is higher than a predefined level. In any regard, the server 130 may generate the command for the appliance 112 based upon the determination and may communicate the generated command to the processor 310. The processor 310 may receive the generated command from the server 130 via the network interface 360 and may cause the appliance 112 to be operated according to the received command.

Turning now to FIG. 7, there is shown an example method 700, which may be executed in conjunction with or as an alternative to the methods 400-600. At block 702, the processor 310 may execute the instructions 334 to track a user's interactions with the appliance 112. The processor 310 may also track an environmental condition along with the user's interactions. For instance, the user's interactions may be tracked by tracking when a user turns the appliance 112 power on and off and the environmental condition at the moments at which the user's interactions occur. The processor 310 may track this information in any of the manners discussed above. For instance, the appliance 112 may include components to track this information and may communicate this information to the processor 310.

At block 704, the processor 310 may execute the instructions 334 to generate a usage pattern of the appliance 112 from the tracked user's interactions with the appliance 112. For instance, the processor 310 may determine what the environmental conditions are when the user interacted with the appliance 112 and may generate the usage pattern from the determination. That is, the usage pattern may denote the environmental conditions present when a user turned on and turned off the appliance 112. In one regard, the generated usage pattern may identify the user's desired environmental condition settings based upon the environmental conditions at the times the user turned off the appliance 112 as that may be an indication that the environmental conditions are at desired levels when the user turned off the appliance 112.

At block 706, the processor 310 may execute the instructions 326 to communicate the generated usage pattern of the appliance 112 to the server 130 via the network interface 360. The server 130 may generate the command for the appliance 112 based upon the generated usage pattern. For instance, the server 130 may determine how the appliance 112 is to be manipulated based upon the generated usage pattern of the appliance 112. By way of particular example, the server 130 may determine that the appliance 112 is to be activated in order for the environmental conditions in the structure 120 to reach certain levels at a particular time, e.g., ata time when a user would like the environmental conditions to be at certain levels. In any regard, the server 130 may generate the command for the appliance 112 based upon the determination and may communicate the generated command to the processor 310. The processor 310 may receive the generated command from the server 130 via the network interface 360 and may cause the appliance 112 to be operated according to the received command.

Some or all of the operations set forth in the methods 400-700 may be contained as utilities, programs, or subprograms, in any desired computer accessible medium. In addition, the methods 400-700 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus for controlling an appliance, said apparatus comprising:
a processor; and
a machine-readable storage medium on which is stored instructions that are to cause the processor to:
track an environmental condition;
generate air quality data from the tracked environmental condition;
communicate the generated air quality data to a server;
receive a command for the appliance from the server, wherein the command corresponds to the generated air quality data; and
cause the appliance to operate according to the received command.

2. The apparatus according to claim 1, further comprising:
a sensor to detect the tracked environmental condition;
an appliance interface, wherein the processor is to interface with the appliance through the appliance interface; and
a network interface, wherein the processor is to communicate with the server via a network through the network interface.

3. The apparatus according to claim 1, wherein the instructions are further to cause the processor to:
access information related to detected motion in a structure; and
compute occupancy in the structure based upon the accessed detected motion information and the tracked environmental condition.

4. The apparatus according to claim 3, wherein the instructions are further to cause the processor to:
communicate the computed occupancy to the server; and
wherein the command received from the server also corresponds to the computed occupancy.

5. The apparatus according to claim 4, wherein the instructions are further to cause the processor to:
determine whether an occupancy in the structure has changed; and
in response to a determined change in occupancy, communicate the determined change in occupancy to the server.

6. The apparatus according to claim 1, wherein the instructions are further to cause the processor to:
monitor energy consumption of the appliance; and
communicate the monitored energy consumption of the appliance to the server, wherein the command received from the server also corresponds to the monitored energy consumption.

7. The apparatus according to claim 1, wherein the instructions are further to cause the processor to:
track a user's interactions with the appliance; and
generate a usage pattern of the appliance from the tracked user's interactions.

8. The apparatus according to claim 7, wherein the instructions are further to cause the processor to:
communicate the generated usage pattern to the server, wherein the command received from the server also corresponds to the generated usage pattern.

9. A method for controlling an appliance, said method comprising:
tracking an environmental condition of an interior of a structure;
generating air quality data from the tracked environmental condition;
communicating the generated air quality data to a server via a network;
receiving a command for the appliance from the server via the network, wherein the command corresponds to the generated air quality data; and
causing, by a processor, the appliance to operate according to the received command.

10. The method according to claim 9, wherein causing the appliance to operate according to the received command further comprises communicating an instruction signal to the appliance, wherein the instruction signal causes the appliance to operate according to the received command.

11. The method according to claim 9, further comprising:
accessing information related to detected motion in the structure; and
computing occupancy in the structure based upon the accessed detected motion information and the tracked environmental condition.

12. The method according to claim 11, further comprising:
communicating the computed occupancy to the server, wherein the command received from the server also corresponds to the computed occupancy.

13. The method according to claim 9, further comprising:
monitoring energy consumption of the appliance;
communicating the monitored energy consumption of the appliance to the server; and
wherein the command received from the server also corresponds to the monitored energy consumption.

14. The method according to claim 9, further comprising:
tracking a user's interactions with the appliance;
generating a usage pattern of the appliance from the tracked user's interactions;
communicating the generated usage pattern to the server; and
wherein the command received from the server also corresponds to the generated usage pattern.

15. An apparatus for controlling an appliance, said apparatus comprising:
a sensor to detect an ambient environmental condition in a structure;
a processor to generate air quality data from the detected ambient environmental condition;
an interface to communicate the generated air quality data to a server over a network; and
wherein the processor is to receive a command for the appliance from the server, the command corresponding to the generated air quality data.

16. The apparatus according to claim 15, further comprising:
a motion sensor to detect motion in the structure; and
an occupancy processor to compute an occupancy of the structure based upon motion detected by the motion sensor and the tracked environmental condition.

17. The apparatus according to claim 16, wherein the processor is to determine whether an occupancy in the structure has changed and, in response to the occupancy being changed, to communicate the determined change in occupancy to the server.

18. The apparatus according to claim 15, further comprising:
an energy consumption monitor to monitor energy consumption of the application, wherein the monitored energy consumption of the application is to be communicated through the interface to the server and the received command also corresponds to the monitored energy consumption.

19. The apparatus according to claim 15, further comprising:
a user interaction monitor to monitor a user's interactions with the appliance;
a usage pattern generator to generate a usage pattern of the appliance from the monitored user's interactions; and
wherein the generated usage pattern is to be communicated through the interface to the server and the received command also corresponds to the generated usage pattern.

20. The apparatus according to claim 15, the processor is to communicate an instruction signal corresponding to the received command to the appliance, the instruction signal to modify an operation of the appliance.
